(19) United States
(12) Patent Application Publication
(10) Pub. No.: US 2015/0137707 A1
(43) Pub. Date: May 21, 2015

(54) LIGHT EMITTING DIODE DRIVING APPARATUS

(71) Applicant: Samsung Electro-Mechanics Co., Ltd., Suwon (KR)

(72) Inventor: Kyu Tae SEO, Suwon (KR)

(73) Assignee: Samsung Electro-Mechanics Co., Ltd., Suwon (KR)

(21) Appl. No.: 14/543,067

(22) Filed: Nov. 17, 2014

(30) Foreign Application Priority Data
Nov. 21, 2013 (KR) 10-2013-0142467

(51) Int. Cl. H05B 33/08

(52) U.S. Cl. CPC H05B 33/0851; H05B 33/0815
USPC 315/307

(57) ABSTRACT

A primary side regulation (PSR) type light emitting diode (LED) driving apparatus may be capable of precisely controlling output power. The LED driving apparatus may include: a power supplying unit converting an input power input to a primary side of the apparatus and supplying a driving power to the LED positioned on a secondary side of the apparatus; a secondary side feedback unit positioned on the secondary side and providing an output control signal based on a current flowing in the LED and a dimming signal; a dimmer positioned on the secondary side and providing the dimming signal; and a primary side feedback unit positioned on the primary side and transferring a feedback signal to the power supplying unit based on a detection signal obtained by indirectly detecting power induced in the secondary side and the output control signal.

### CROSS-REFERENCE TO RELATED APPLICATION

This application claims the benefit of Korean Patent Application No. 10-2013-0142467 filed on Nov. 21, 2013, with the Korean Intellectual Property Office, the disclosure of which is incorporated herein by reference.

### BACKGROUND

The present disclosure relates to a light emitting diode (LED) driving apparatus capable of driving an LED by supplying power to the LED.

Recently, interests in and demands for light emitting diodes (LEDs) have increased.

A device using the LED may be compactly manufactured to thereby be used in a location in which it is difficult to install an existing electronic product. Furthermore, when an LED is used as an illumination apparatus, the LED may easily implement various colors of light and have easily controllable illuminance, such that the LED may be used in the illumination apparatus appropriate for situations such as watching movies, reading, conferencing, or the like.

In addition, LEDs consume about one-eighth of the power consumed by incandescent lamps, have a lifespan of fifty thousand to one hundred thousand hours, 5 to 10 times longer than the lifespan of incandescent lamps, and is environment-friendly as a mercury free light source, and may be variously designed.

Due to the above characteristics, LED illumination projects have been promoted as national projects in many nations such as America, Japan, Australia, and others, in addition to Korea.

As described above, LEDs, the use of which has increased, require a driving apparatus for the driving thereof. As described in the following Related Art Document, in the case of using direct current (DC) power, since a circuit supplying the DC power may be relatively complicated, a technology of driving an LED using rectified power has been developed. However, in this technology, regulation characteristics of a current transferred to the LED are deteriorated.

### RELATED ART DOCUMENT

### Patent Document

(Patent Document 1) Korean Patent Laid-Open Publication No. 2011-0098811

### SUMMARY

An aspect of the present disclosure may provide a primary side regulation (PSR) type light emitting diode (LED) driving apparatus capable of precisely controlling output power.

According to an aspect of the present disclosure, an LED driving apparatus may include: a power supplying unit converting an input power input to a primary side of the apparatus and supplying the power to the LED positioned on a secondary side of the apparatus; a secondary side feedback unit positioned on the secondary side and providing an output control signal based on a current flowing in the LED and a dimming signal; and a primary side feedback unit positioned on the primary side and transferring a feedback signal to the power supplying unit based on a detection signal obtained by indirectly detecting power induced to the secondary side and the output control signal.

The power supplying unit may include: a power converter including a switch switching the input power and a transformer having a primary winding receiving the power switched by the switch, a secondary winding insulated from the primary winding and receiving the power induced from the primary winding depending on a turns ratio of the primary winding to the secondary winding, and an auxiliary winding positioned on the primary side and detecting the power induced from the primary winding to the secondary winding; and a controller controlling the switch, based on the feedback signal.

The primary side feedback unit may receive a detection signal transferred from the auxiliary winding, the detection signal being obtained by detecting the power induced from the primary winding to the secondary winding.

The LED driving apparatus may further include a primary-secondary insulating means transferring the output control signal from the secondary side feedback unit to the primary side feedback unit.

The primary-secondary insulating means may be one of a photo-coupler and a one-to-one transformer.

The secondary side feedback unit may include: a detector detecting a current flowing in the LED; and a feedback controller providing the output control signal based on a current detection signal from the detector and the dimming signal input to the secondary side.

The feedback controller may provide the output control signal so as to allow the current flowing in the LED to be in accord with a current command value included in the dimming signal.

According to another aspect of the present disclosure, an LED driving apparatus may include: a power supplying unit converting an input power input to a primary side of the apparatus and supplying a driving power to the LED positioned on a secondary side of the apparatus; a secondary side feedback unit positioned on the secondary side and providing an output control signal based on a current flowing in the LED and a dimming signal; a dimmer positioned on the secondary side and providing the dimming signal; and a primary side feedback unit positioned on the primary side and transferring a feedback signal to the power supplying unit based on a detection signal obtained by indirectly detecting power induced in the secondary side and the output control signal.

The secondary side feedback unit may include: a detector detecting a current flowing in the LED; and a feedback controller providing the output control signal based on a current detection signal from the detector and the dimming signal from the dimmer.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic circuit diagram of alight emitting diode (LED) driving apparatus according to an exemplary embodiment of the present disclosure;

FIG. 2 is a circuit diagram schematically illustrating an example of a primary-secondary insulating means used in the LED driving apparatus according to an exemplary embodiment of the present disclosure shown in FIG. 1; and

FIG. 3 is a lookup table of a feedback controller used in the LED driving apparatus according to an exemplary embodiment of the present disclosure shown in FIG. 1.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

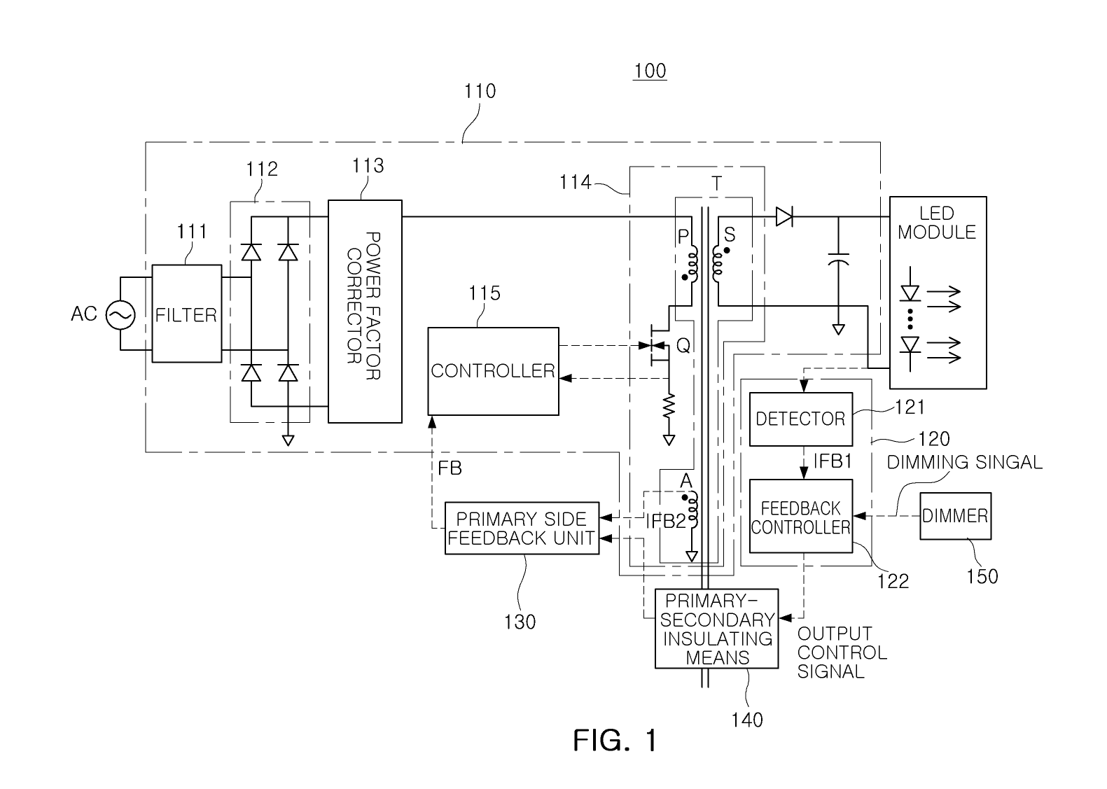

FIG. 1 is a schematic circuit diagram of a light emitting diode (LED) driving apparatus according to an exemplary embodiment of the present disclosure.

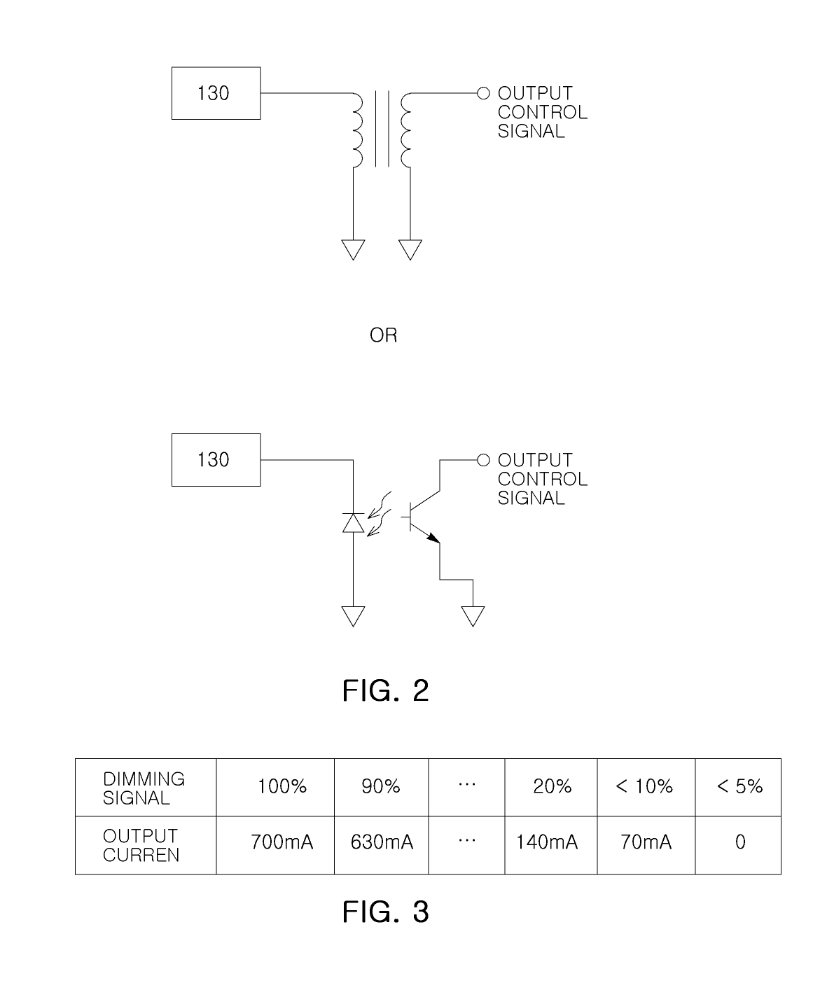

FIG. 2 is a circuit diagram schematically illustrating an example of a primary-secondary insulating means used in the LED driving apparatus according to an exemplary embodiment of the present disclosure shown in FIG. 1.

FIG. 3 is a lookup table of a feedback controller used in the LED driving apparatus according to an exemplary embodiment of the present disclosure shown in FIG. 1.

Referring to FIG. 1, the LED driving apparatus 100 according to an exemplary embodiment of the present disclosure may include a power supplying unit 110, a secondary side feedback unit 120, a primary side feedback unit 130, a primary-secondary insulating means 140, and a dimmer 150.

In the LED driving apparatus 100, a primary side and a secondary side insulated from each other may be formed, and the power supplying unit 110 may convert power input to the primary side and supply the converted power to an LED positioned on the secondary side.

The power supplying unit 110 may include a filter 110, a rectifier 112, a power factor corrector 113, a power converter 114, and a controller 115.

The filter 111, the rectifier 112, the power factor corrector 113, and the controller 115 may be positioned on the primary side, and the power converter 114 may be positioned across the primary side and the secondary side.

The filter 111 may remove a noise component of input alternating current (AC) power, a noise component generated due to switching of power of the power converter 114, or the like.

The rectifier 112 may rectify the AC power filtered by the filter 111 and transfer the rectified power to the power factor corrector 113.

The power factor corrector 113 may switch the power rectified by the rectifier 112 to correct a phase difference between a voltage and a current of the rectified power, thereby correcting a power factor. In addition, the power factor corrector 113 may correct a current waveform of the rectified power so as to follow a voltage waveform, thereby correcting a power factor.

The power converter 114 may include a switch Q switching the power of which the power factor is corrected by the power factor corrector 113 depending on a control of the controller 115 and a transformer T.

The transformer T may include a primary winding P, a secondary winding S, and an auxiliary winding A.

The primary winding P and the auxiliary winding A may be positioned on the primary side, and the secondary winding S may be positioned on the secondary side.

The primary winding P may have a preset turn, have one end connected to the power factor corrector 113 to receive the power of which the power factor is corrected, and have the other end connected to the switch Q to enable an operation in which the power is converted depending on on/off switching operations of the switch Q.

The secondary winding S may have a preset turns amount, may be electrically insulated from the primary winding P and be magnetically coupled to the primary winding P to form a preset turns ratio of the primary winding P to the second winding S, and may receive the power switched by the switch Q and induced from the primary winding P, transform the received power into a voltage depending on the turns ratio, and output the transformed power. The power output from the secondary winding S may be stabilized by a diode and a capacitor and be then supplied to the LED.

A plurality of LEDs may be provided to configure an LED module.

The auxiliary winding A may indirectly detect the power induced from the primary winding P to the secondary winding S and provide the detected power to the primary side feedback unit 130.

The controller 115 may control the on/off switching of the switch Q depending on a feedback signal (FB) to control a power level supplied to the LED.

A scheme of controlling the on/off switching of the switch Q based on a current detection signal IFB1 indirectly detected by the auxiliary winding A to control the power level supplied to the LED may be called a primary side regulation (PSR) scheme.

In addition, the LED driving apparatus 100 according to an exemplary embodiment of the present disclosure may receive an output control signal transferred from the secondary side to control the on/off switching of the switch Q together with the current detection signal IFB1.

The secondary side feedback unit 120 may include a detector 121 and a feedback controller 122.

The detector 121 may transfer the current detection signal IFB1 obtained by detecting a current flowing in the LED to the feedback controller 122.

The feedback controller 122 may provide the output control signal based on the detection signal IFB1 from the detector 121 and a dimming signal from the dimmer 150.

The output control signal from the feedback controller 122 may be transferred to the primary side feedback unit 130 through the primary-secondary insulating means 140.

The dimmer 150 may provide the dimming signal for controlling brightness of the LED. Referring to FIG. 3, current levels (700 mA to 0 mA) that need to flow in the LED depending on a degree of brightness (100% to 0%) of the dimming signal may be previously stored as a lookup table in the feedback controller 122.

The feedback controller 122 may determine whether a current level corresponding to a brightness degree of the dimming signal flows in the LED based on detection information of the current detection signal IFB1 with reference to the lookup table and may provide the output control signal so as to increase, maintain, or decrease the power level supplied to the LED in order to allow the current level flowing in the LED to be in accord with a current command value of the current level corresponding to the brightness degree of the dimming signal depending on a determination result.

The output control signal may be transferred from the secondary side electrically insulated from the primary side to the primary side through the primary-secondary insulating means 140.

Referring to FIG. 2, the primary-secondary insulating means 140 may have one end formed on the secondary side to receive the output control signal and the other end formed on the primary side to transfer the received output control signal to the primary side feedback unit 130.

Here, the primary-secondary insulating means 140 may include one of a photo-coupler converting the received output control signal into an optical signal and transferring the optical signal from the secondary side to the primary side and a transformer transferring the received output control signal through primary and secondary windings electrically insulated from and magnetically coupled to each other.

The primary side feedback unit 130 may transfer the feedback signal FB to the controller 115 based on the detection signal IFB2 indirectly detected by the auxiliary winding A and the output control signal transferred from the primary-secondary insulating means 140.

The feedback signal FB may include information on a target value of the power supplied to the LED, and the controller 115 may control the on/off switching of the switch Q depending on the information to control the power level supplied to the LED.

As set forth above, according to an exemplary embodiment of the present disclosure, in a primary side regulation (PSR) type LED driving apparatus indirectly detecting the power induced from the primary side to the secondary side to control the power supplied to the LED disposed at the secondary side, the output power of the LED driving apparatus is corrected based on the dimming signal of the secondary side and the current flowing in the LED depending on the dimming signal, whereby output power regulation may be precisely maintained and the output power by the dimming signal may be precisely controlled.

While exemplary embodiments have been shown and described above, it will be apparent to those skilled in the art that modifications and variations could be made without departing from the scope of the present invention as defined by the appended claims.

What is claimed is:

1. A light emitting diode (LED) driving apparatus comprising:
a power supplying unit converting an input power input to a primary side of the apparatus and supplying a driving power to an LED positioned on a secondary side of the apparatus insulated from the primary side;
a secondary side feedback unit positioned on the secondary side and providing an output control signal based on a current flowing in the LED and a dimming signal; and
a primary side feedback unit positioned on the primary side and transferring a feedback signal to the power supplying unit based on a detection signal obtained by indirectly detecting power induced in the secondary side and the output control signal.

2. The LED driving apparatus of claim 1, wherein the power supplying unit includes:
a power converter including a switch switching the input power and a transformer having a primary winding receiving the power switched by the switch, a secondary winding insulated from the primary winding and receiving the power induced from the primary winding depending on a turns ratio of the primary winding to the secondary winding, and an auxiliary winding positioned on the primary side and detecting the power induced from the primary winding to the secondary winding; and
a controller controlling the switch, based on the feedback signal.

3. The LED driving apparatus of claim 2, wherein the primary side feedback unit receives a detection signal transferred from the auxiliary winding, the detection signal being obtained by detecting the power induced from the primary winding to the secondary winding.

4. The LED driving apparatus of claim 1, further comprising a primary-secondary insulating means transferring the output control signal to the primary side feedback unit.

5. The LED driving apparatus of claim 4, wherein the primary-secondary insulating means is one of a photo-coupler and a one-to-one transformer.

6. The LED driving apparatus of claim 1, wherein the secondary side feedback unit includes:
a detector detecting a current flowing in the LED; and
a feedback controller providing the output control signal based on a current detection signal from the detector and the dimming signal input to the secondary side.

7. The LED driving apparatus of claim 6, wherein the feedback controller provides the output control signal so as to allow the current flowing in the LED to be in accord with a current command value included in the dimming signal.

8. An LED driving apparatus comprising:
a power supplying unit converting an input power input to a primary side of the apparatus and supplying a driving power to the LED positioned on a secondary side of the apparatus;
a secondary side feedback unit positioned on the secondary side and providing an output control signal based on a current flowing in the LED and a dimming signal;
a dimmer positioned on the secondary side and providing the dimming signal; and
a primary side feedback unit positioned on the primary side and transferring a feedback signal to the power supplying unit based on a detection signal obtained by indirectly detecting power induced in the secondary side and the output control signal.

9. The LED driving apparatus of claim 8, wherein the power supplying unit includes:
a power converter including a switch switching the input power and a transformer having a primary winding receiving the power switched by the switch, a secondary winding insulated from the primary winding and receiving the power induced from the primary winding depending on a turns ratio of the primary winding to the secondary winding, and an auxiliary winding positioned on the primary side and detecting the power induced from the primary winding to the secondary winding; and
a controller controlling the switch, based on the feedback signal.

10. The LED driving apparatus of claim 9, wherein the primary side feedback unit receives a detection signal transferred from the auxiliary winding, the detection signal being obtained by detecting the power induced from the primary winding to the secondary winding.

11. The LED driving apparatus of claim 8, further comprising a primary-secondary insulating means transferring the output control signal from the secondary side feedback unit to the primary side feedback unit.

12. The LED driving apparatus of claim 11, wherein the primary-secondary insulating means is one of a photo-coupler and a one-to-one transformer.

13. The LED driving apparatus of claim 8, wherein the secondary side feedback unit includes:
a detector detecting a current flowing in the LED; and
a feedback controller providing the output control signal based on a current detection signal from the detector and the dimming signal from the dimmer.

14. The LED driving apparatus of claim 13, wherein the feedback controller provides the output control signal so as to allow the current flowing in the LED to be in accord with a current command value included in the dimming signal.
